(19) United States
(12) Patent Application Publication
(10) Pub. No.: US 2003/0073039 A1
(43) Pub. Date: Apr. 17, 2003

(54) Method of forming a patterned photoresist with a non-distorted profile

(76) Inventor: Chi-Yuan Hung, Ilan (TW)

Correspondence Address: POWELL, GOLDSTEIN, FRAZER & MURPHY LLP, P.O. BOX 97223, WASHINGTON, DC, 20090-7223, US

(21) Appl. No.: 09/978,155

(22) Filed: Oct. 16, 2001

(51) Int. Cl. G03C 5/00

(52) U.S. Cl. 430/312; 430/311; 430/317; 430/322

(57) ABSTRACT

A method of forming a patterned photoresist with a non-distorted profile. A first photoresist is formed on a substrate. The first photoresist is suitable for patterning a trench pattern. A second photoresist is formed on the first photoresist. The second photoresist is suitable for patterning an iso-line pattern. A photolithography step is then performed to pattern the second and the first photoresist to form a patterned photoresist.

### BACKGROUND OF THE INVENTION

1 Field of Invention

The present invention relates to a method of manufacturing semiconductor integrated circuits. More particularly, the present invention relates to a method of forming a patterned photoresist with a non-distorted profile.

2. Description of Related Art

Lithography is a very important process in the fabricating processes of integrated circuits (IC). Lithography is related to pattern transferring, and thus it is related to the reliability of the IC. Photolithography is the most commonly used form of lithography. The common way is to make a photomask with a pattern on it, after which an exposing light is transmitted through the photomask to transfer the pattern to a photoresist. This method of transferring a pattern can greatly increase the productivity, and thus it can greatly decrease the production cost.

The main exposing technology is to use a light source generating light radiation of 248 nm and 193 nm. The 248 nm light radiation is used in a KrF exposer, which can be applied in a 0.25-0.15 μm semiconductor process. The 193 nm light radiation is used in an ArF exposer, which can be applied in a 0.18-0.13 μm semiconductor process.

For the KrF photoresist, the components of the photoresist are mainly composed of polymer, photo-acid generator (PAG), acid quencher, additive and solvent. The reaction mechanism of photolithography is catalysis of the deprotection reaction of polymer by photo-acids, which are generated by exposing the photoresist, to increase the solubility of the exposed polymer in the developing solution. The acid quencher in the photoresist can be used to adjust the diffusion ability of the photo-acids. The additive is used to increase the tolerance of basic materials in the environment. The solvent serves as a reaction matrix for the chemical reaction described above.

For the ArF photoresist, the aromatic ring of the polymer is changed to an alicyclic structure to increase the penetration ability of 193 nm light radiation and the anti-etching ability of the photoresist. The other components, such as the photo-acid generator (PAG), neutral additive and basic additive, also need to be adjusted according to the chemical structure of the polymer. For example, higher electron-transfer ability is needed for the PAG of the ArF photoresist. The addition of the neutral additive can affect the photoresist's solubility, optical properties, thermal properties and surface properties. Regarding the basic additive, the environmental stability of the photoresist, diffusion ability of acid materials, contrast ability and the deprotection rate are affected by the addition of the basic additive.

Generally speaking, the properties of various photoresists are varied to meet the requirements of various types of pattern to be transferred. For example, a photoresist used to transfer a trench pattern requires a fast photo-acids diffusion rate and a low contrast ability. However, the requirements for a photoresist used to transfer an iso-line pattern are a slow photo-acids diffusion rate and a high contrast ability. If different types of pattern needed to be transferred at the same time, it is hard to meet the different requirements of the different types of pattern.

### SUMMARY OF THE INVENTION

It is therefore an objective of the present invention to provide a method of forming a patterned photoresist with a non-distorted profile. No footing structure is formed on the bottom of the exposed photoresist, and a good profile of the patterned photoresist is maintained.

It is another an objective of the present invention to provide a method of forming a patterned photoresist with a non-distorted profile to facilitate forming patterns of dense-line and iso-line at the same time.

It is still another an objective of the present invention to provide a method of forming a patterned photoresist with a non-distorted profile to greatly increase the process window.

In accordance with the foregoing and other objectives of the present invention, a method of forming a patterned photoresist with a non-distorted profile is provided. A first photoresist is formed on a substrate, and the first photoresist is suitable for patterning a trench pattern. A second photoresist is formed on the first photoresist, and the second photoresist is suitable for patterning an iso-line pattern. A photolithography step is then performed to pattern the second and the first photoresist to form a patterned photoresist.

In the foregoing, the photo-acids diffusion rate in the first photoresist is faster than that in the second photoresist and the contrast ability of the first photoresist is lower than that of the second photoresist. Therefore, the first photoresist is preferably sufficiently thick to avoid footing formation, and the second photoresist is preferably sufficiently thick to be an etching mask for a subsequent etching step.

In summary, the invention allows a wider process window for the photolithography process because the first photoresist lies under the second photoresist. Since the photo-acids diffusion rate in the first photoresist is faster than that in the second photoresist and the contrast ability of the first photoresist is lower than that of the second photoresist, there is no footing formation on the bottom of the exposed photoresist. Thus, a non-distorted profile of the patterned photoresist can be obtained.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIGS. 1-2 are schematic, cross-sectional views showing a process of forming a patterned photoresist with a non-distorted profile according to one preferred embodiment of this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

As described above, a photoresist used to transfer a trench pattern requires a fast photo-acids diffusion rate and a low contrast ability. Since the photo-acids diffusion rate is faster and the contrast ability is lower, the photo-acids can easily diffuse to the bottom of the photoresist and the bottom of the photoresist can be fully exposed. Therefore, no residue is left in the bottom of the exposed regions of the photoresist to form footing structures after developing the photoresist.

However, a photoresist used to transfer an iso-line pattern requires a slow photo-acids diffusion rate and a high contrast ability. Since the photo-acids diffusion rate is slower and the contrast ability is higher, the photo-acids cannot easily diffuse to the iso-line, i. e. the unexposed part, and the iso-line cannot be easily exposed to form a rounding corner structure after developing the photoresist.

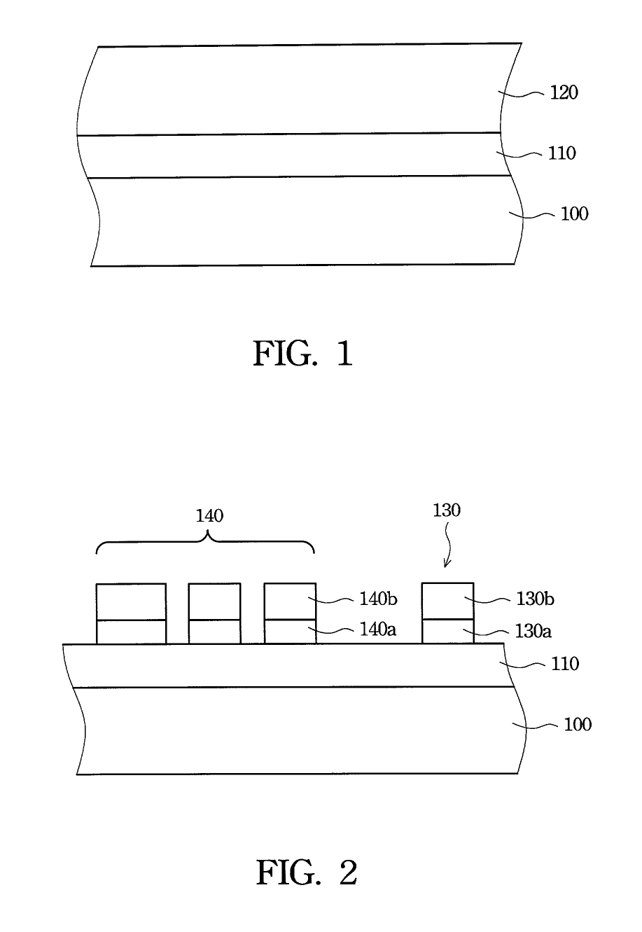

Please refer to FIGS. 1-2. FIGS. 1-2 are schematic, cross-sectional views showing a process of forming a patterned photoresist with a non-distorted profile according to one preferred embodiment of this invention. In FIG. 1, a first photoresist 110 is formed on the substrate 100, and then a second photoresist 120 is formed on the first photoresist 110. The formation method of the first photoresist 110 and the second photoresist 120 can be, for example, spin-on coating. The properties of the first photoresist are a faster photo-acids diffusion rate and a lower contrast ability. The properties of the second photoresist are a slower photo-acids' diffusion rate and a faster contrast ability.

In FIG. 2, an exposure step and a development step are performed to form a patterned photoresist having iso-line pattern 130 and dense-line pattern 140. Since the photo-acids diffusion rate in the second photoresist 130b and 140b, which is in the upper layer of the patterned photoresist, is slower and the contrast ability is higher, the top corner is not rounded. The photo-acids' diffusion rate in the first photoresist 130a and 140a, which is in the lower layer of the patterned photoresist, is faster and the contrast ability is lower; therefore, the polymer in the exposed parts can completely react to leave no scum at the bottom of the exposed part. As a result, a patterned photoresist with a non-distorted profile is obtained.

As for the thickness of the first photoresist, the thickness of the first photoresist needs to be thin enough to leave no scum at the bottom of the photoresist; that is, no footing structure is formed at the bottom of the exposed part of the first photoresist. The thickness of the second photoresist is preferably thick enough to serve as an etching mask for a later etching step. Therefore, the thickness of the second photoresist is determined by the desired etching depth and the etching selectivity between the second photoresist and the desired etching material.

From the foregoing, this invention provides a method of forming a patterned photoresist with non-distorted profile. The photoresist suitable for patterning an iso-line is formed on the photoresist suitable for patterning a trench to avoid footing formation and the rounded corner formed on the top corner of the patterned photoresist.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of forming a patterned photoresist with a non-distorted profile, comprising:
forming a first photoresist on a substrate, the first photoresist being suitable for patterning a trench pattern;
forming a second photoresist on the first photoresist, the second photoresist being suitable for patterning an iso-line pattern; and
performing photolithography to pattern the second and the first photoresist to form a patterned photoresist.

2. The method of claim 1, wherein a diffusion rate of photo-acids in the first photoresist is faster than that of photo-acids in the second photoresist during photolithography.

3. The method of claim 1, wherein contrast ability of the first photoresist is lower than contrast ability of the second photoresist during photolithography.

4. The method of claim 1, wherein the first photoresist is thin enough to avoid footing formation after photolithography.

5. The method of claim 1, wherein thickness of the second photoresist is determined by a desired etching depth and an etching selectivity of the second photoresist and a desired etching material.

6. The method of claim 1, wherein the second photoresist is thick enough to be an etching mask for a later etching.

7. A method of forming a patterned photoresist with a non-distorted profile, comprising:
forming a first photoresist on a substrate;
forming a second photoresist on the first photoresist;
exposing the second and the first photoresist, wherein a diffusion rate of photo-acids generated during exposure in the first photoresist is faster than that of photo-acids in the second photoresist; and
developing the first and the second photoresists to form a patterned photoresist.

8. The method of claim 7, wherein the first photoresist is thin enough to avoid footing formation after photolithography.

9. The method of claim 7, wherein a thickness of the second photoresist is determined by a desired etching depth and an etching selectivity of the second photoresist and a desired etching material.

10. The method of claim 7, wherein the second photoresist is thick enough to be an etching mask for a later etching.

11. A method of forming a patterned photoresist with a non-distorted profile, comprising:
forming a first photoresist on a substrate;
forming a second photoresist on the first photoresist; and
performing photolithography to pattern the second and the first photoresist, wherein a contrast ability of the first photoresist is lower than that of the second photoresist.

12. The method of claim 11, wherein the first photoresist is thin enough to avoid footing formation after photolithography.

13. The method of claim 11, wherein a thickness of the second photoresist is determined by a desired etching depth and an etching selectivity of the second photoresist and a desired etching material.

14. The method of claim 11, wherein the second photoresist is thick enough to be an etching mask for a later etching.
